(19) United States
(12) Patent Application Publication
(10) Pub. No.: US 2012/0067291 A1
(43) Pub. Date: Mar. 22, 2012

(54) Processes For Treating Aquatic Organisms And Liquid

(75) Inventors: David Drahos, Roanoke, VA (US); Christian Munch, Frederiksberg (DK)

(73) Assignees: Novozymes Biologicals, Inc., Salem, VA (US); Novozymes A/S, Bagsvaerd (DK)

(21) Appl. No.: 13/211,949

(22) Filed: Aug. 17, 2011

Related U.S. Application Data
(60) Provisional application No. 61/374,881, filed on Aug. 18, 2010.

(51) Int. Cl. A01K 61/00

(52) U.S. Cl. 119/200

(57) ABSTRACT

The disclosure provides processes that maintain or adjust levels of ammonia and nitrite in a liquid. The processes utilize a bacterial composition capable of oxidizing ammonia and nitrite. The processes are useful in the rescue or preservation of aquatic organisms.

### CROSS-REFERENCE TO RELATED APPLICATIONS

This application claims the benefit under 35 U.S.C. 119 of U.S. provisional application No. 61/374,881 filed 18 Aug., 2010, the contents of which are fully incorporated herein by reference.

### FIELD OF THE INVENTION

The present disclosure relates generally to processes useful in the treatment, rescue or preservation of aquatic organisms. More particularly, the present disclosure relates to processes that utilize a nitrifying bacterial composition to maintain or adjust levels of harmful components in an aquatic organism's environment.

### BACKGROUND

Aquatic animals serve as a major food source and play a vital role in scientific exploration. Aquatic animals must typically be kept alive during transportation thereby creating a need for efficient means for keeping the aquatic animals alive for periods of time in captivity. Transportation systems for aquatic animals such as seafood typically consist of containers having tanks filled with cold freshwater or seawater. Transportation of aquatic animals over long distances presents a considerable challenge because the storage water becomes contaminated with nitrogenous waste while oxygen content is decreased. Ammonia and nitrite can be generated by the decomposition of organic matter (e.g., fecal matter) and excess feed. Temperature, pH, and oxygen levels also influence ammonia generation. In the absence of naturally-occurring bacteria (i.e., in a storage container or tank), increased ammonia levels create toxic conditions, increase blood pH, reduce oxygen conductivity in the blood, affect gill health, and increase mortality rates for aquatic organisms. Thus, there exists not only a need for an economically, viable means of nitrifying an aquatic organism-containing liquid, but an economically, viable means of transport and storage of live aquatic animals that require long-term survival under particularly cold temperature conditions.

### SUMMARY

The present disclosure provides, in one aspect, a process for nitrifying an aquatic organism-containing liquid that includes introducing a bacterial composition to the liquid. The bacterial composition includes an ammonia oxidizing bacterium and a nitrite oxidizing bacterium. The temperature of the liquid is less than or equal to 10° C.

In one aspect, the present disclosure provides a process for maintaining nitrite or ammonia levels in a liquid wherein the temperature of the liquid is less than or equal to 10° C. comprising introducing to the liquid a bacterial composition that includes an ammonia oxidizing bacterium and a nitrite oxidizing bacterium.

In another aspect, the present disclosure provides a process for preserving aquatic organisms in an ammonia-containing or nitrite-containing liquid comprising storing the aquatic organisms in the presence of a bacterial composition that includes an ammonia oxidizing bacterium and a nitrite oxidizing bacterium.

In one aspect, the present disclosure provides a process for rescuing aquatic organisms in liquid containing ammonia, nitrite, or a combination thereof by introducing a bacterial composition to the liquid. The bacterial composition liquid includes an ammonia oxidizing bacterium and a nitrite oxidizing bacterium. Upon introduction, the bacterial composition instantaneously begins to oxidize any ammonia or nitrite present in the liquid.

In another aspect, the present disclosure provides a process for transporting live aquatic organisms in a liquid-containing tank comprising introducing aquatic organisms to the liquid-containing tank and introducing a bacterial composition to the liquid. The bacterial composition includes an ammonia oxidizing bacterium and a nitrite oxidizing bacterium. The temperature of the liquid is at or above the freezing point of the liquid.

In yet another aspect, the present disclosure provides a process of aquatic organism resourcing comprising regulating the level of ammonium and nitrite in an aquatic organism's environment.

In yet another aspect, the present disclosure relates to a method of treating an aquatic organism in need thereof including contacting a liquid with the aquatic organism therein with an effective amount of bacterial composition, wherein the bacterial composition includes an ammonia oxidizing bacterium and a nitrite oxidizing bacterium, and wherein the temperature of the liquid is less than or equal to 10° C. Non-limiting examples of suitable temperatures of the liquid is a temperature equal to or less than 9° C., 8° C., 7° C., 6° C., 5° C., 4° C., 3° C., 2° C., or 1° C. Additional suitable temperatures include a temperature of the liquid at 1° C.-10° C., 1-5° C. or 1-3° C. In embodiments, the bacterial composition is added to the liquid in an amount capable of removing 0.25-25 mg N—NH₃/L/hr. In embodiments, the amount of ammonia oxidizing bacterium added to the liquid is an amount sufficient to remove 0.25-25 mg N—NH₃/L/hr. In embodiments, the amount of nitrite oxidizing bacterium added to the liquid is an amount sufficient to remove 0.25-25 mg N—NH₃/L/hr. In embodiments, the bacterial composition includes Nitrosomonas eutropha as the ammonia oxidizing bacterium and Nitrobacter winogradskyi as the nitrite oxidizing bacterium. In embodiments, the bacterial composition includes Nitrosomonas eutropha in combination with Nitrobacter winogradskyi. In embodiments, the bacterial composition Nitrosococcus as an ammonia oxidizing bacterium in combination with Nitrococcus as a nitrite oxidizing bacterium.

The present disclosure includes combinations of aspects and embodiments described herein.

### DETAILED DESCRIPTION OF THE PREFERRED EMBODIMENTS

The term “aquatic organisms” includes, but is not limited to, marine fish, shellfish, and all aquatic animals, including, but not limited to, saltwater fish, freshwater fish, crustaceans, molluscs, and reptiles. Aquatic organisms also include commercial important animals including but not limited to shrimp, eel, lobster, oyster, clam and bait fish.

The bacterial compositions of the processes described herein are capable of promoting a healthy environment for an aquatic organism in an environmentally safe manner by reducing both ammonia and nitrite toxicity, reducing waste or sludge accumulation, removing excess nutrients, degrading organic compounds such as excess aquatic organism food and waste, and increasing water clarity. The bacterial compositions utilize a combination of at least two nitrifying bacteria that work together to convert harmful ammonia first to nitrite and then to a harmless nitrate. As the ammonia and nitrite levels rise, the bacterial composition is capable of growing at a rate to allow for efficient nitrification. The bacterial compositions described herein are further capable of oxidizing ammonia and nitrite despite the level of food consumption by the aquatic organism prior to introduction of the bacterial composition to the aquatic organism's environment.

Processes for nitrifying an aquatic organism-containing liquid are provided. In one embodiment, the process for nitrifying an aquatic organism-containing liquid includes the step of introducing a bacterial composition to the liquid. The bacterial composition includes an ammonia oxidizing bacterium and a nitrite oxidizing bacterium. The bacterial composition is capable of oxidizing ammonia and nitrite that might be present in a liquid when the temperature of the liquid is less than or equal to 10° C. Non-limiting example of a suitable temperature of the liquid include temperatures equal to or less than 9° C., 8° C., 7° C., 6° C., 5° C., 4° C., 3° C., 2° C., or 1° C. In embodiments, the temperature of the liquid is 1° C.-10° C., 1-5° C. or 1-3° C. Non-limiting examples of suitable combinations of bacterial compositions include Nitrosomonas eutropha in combination with Nitrobacter winogradskyi and Nitrosococcus in combination with Nitrococcus.

In one embodiment, nitrite or ammonia levels in a liquid are maintained with a temperature of less than or equal to 10° C. The process includes the step of introducing to the liquid a bacterial composition that includes an ammonia oxidizing bacterium and a nitrite oxidizing bacterium. In one embodiment of the process, the liquid includes at least one aquatic organism. In embodiments, the liquid includes a number of organisms such as two or more, three or more, four or more, five or more, six or more, seven or more, eight or more, nine or more, or ten or more such as 20, 30, 40, 50 or more.

Aquatic organisms in an ammonia-containing or nitrite-containing liquid can be preserved according to a process that includes the step of storing the aquatic organisms in the presence of a bacterial composition that includes an ammonia oxidizing bacterium and a nitrite oxidizing bacterium.

Aquatic organisms in distress or otherwise exhibiting one or more symptoms of physical harm as a result of contaminated storage conditions can be rescued within in an ammonia-containing or nitrite-containing liquid by a process that includes introducing a bacterial composition to the liquid containing the aquatic organisms. The bacterial composition includes an ammonia oxidizing bacterium and a nitrite oxidizing bacterium. Upon introduction, the bacterial composition begins to oxidize any ammonia or nitrite present in the liquid in an instantaneous or substantially instantaneous manner providing rapid recovery from nitrification thereby preventing death or permanent physical damage to the health of the aquatic organism. In embodiments, the bacterial composition begins to oxidize any ammonia or nitrite present in the liquid after a period of time such as 1-10 hours. In embodiments, the bacterial composition begins to oxidize any ammonia or nitrite present in the liquid after a period of time such as 5, 6, 7, 8, 9 or 10 hours.

A process for transporting live aquatic organisms in a liquid-containing tank is also provided. The process includes the steps of introducing aquatic organisms to the liquid-containing tank and introducing a bacterial composition to the liquid. The bacterial composition includes an ammonia oxidizing bacterium and a nitrite oxidizing bacterium. The temperature of the liquid is maintained at or above the freezing point of the liquid. In one embodiment, the liquid comprises a component for lowering the standard freezing point of the liquid including, but not limited to, ethanol, sodium bicarbonate, ammonium sulfate, calcium chloride, calcium magnesium acetate, magnesium chloride, potassium chloride, and sodium chloride.

A process of aquatic organism resourcing is provided. The process includes regulating the level of ammonium and nitrite in an aquatic organism's environment. In embodiments, ammonium and nitrate are maintained or adjusted to 0 to 10 ppm N—NH₃ at a pH of 7.0 to 8.5. In embodiments, ammonium and nitrate are maintained or adjusted to 1 to 10 ppm N—NH₃ at a pH of 7.0 to 8.5. In embodiments, ammonium and nitrate are maintained or adjusted to 1 to 5 ppm N—NH₃ at a pH of 7.0 to 8.5. In embodiments, ammonium and nitrate are maintained or adjusted to 1 to 3 ppm N—NH₃ at a pH of 7.0 to 8.5. In one embodiment, regulating the level of ammonium and nitrite is accomplished by introducing a bacterial composition to the environment. The bacterial composition includes an ammonia oxidizing bacterium and a nitrite oxidizing bacterium. The process can be integrated as part of a resourcing regime within an aquaculture, mariculture or aquaponics program for raising, cultivating or maintaining aquatic organisms under controlled conditions.

The bacterial composition of the processes provided herein includes a consortium of at least one ammonia oxidizing bacterium and at least one nitrite oxidizing bacterium. Suitable ammonia oxidizing bacterium include, but are not limited to, Nitrosococcus, Nitrosomonas eutropha, and combinations thereof. Suitable nitrite oxidizing bacterium include, but are not limited to, Nitrobacter winogradskyi, Nitrococcus, and combinations thereof.

In one embodiment, the bacterial composition includes a consortium that includes Nitrosococcus as an ammonia oxidizing bacterium and Nitrococcus as a nitrite oxidizing bacterium. In a preferred embodiment, the bacterial composition includes a consortium that includes Nitrosomonas eutropha as an ammonia oxidizing bacterium and Nitrobacter winogradskyi as a nitrite oxidizing bacterium. The ammonia oxidizing bacterium and nitrite oxidizing bacterium may be used together in combination with each other or with other bacteria (e.g., Bacillus such as the commercial product Prawn Bac PB-628 (product of Novozymes Biologicals), Enterobacter or Pseudomonas).

The bacterial composition may be formulated as a liquid, a lyophilized powder, or a biofilm (e.g., on bran or corn gluten). In a preferred embodiment, the bacterial composition is formulated as a ready-to-use liquid. In one embodiment, the ammonia oxidizing bacterium is inoculated to a NH₃ oxidation rate of 0.01-20 mg N—NH₃/L/hr. In a preferred embodiment, the ammonia oxidizing bacterium is inoculated to a NH₃ oxidation rate of 0.3-6 mg N—NH₃/L/hr. In one embodiment, the nitrite oxidizing bacterium is inoculated to a NO₂ oxidation rate of 0.003-6 mg N—NO₂/L/hr. In a preferred embodiment, the nitrite oxidizing bacterium is inoculated to a NO₂ oxidation rate of 0.01-3 mg N—NO₂/L/hr.

The bacterial composition may be cultivated in a batch culture by methods known in the art (See, e.g., H Koops, U Purkhold, A Pommerening-Roser, G Timmermann, and M Wagner, “The Lithoautotrophic Ammonia-Oxidizing Bacteria,” in M. Dworkin et al., eds., The Prokaryotes: An Evolving Electronic Resource for the Microbiological Community, 3rd edition, release 3.13, 2004, Springer-Verlag, New York).

Under conditions of nitrifying an aquatic organism-containing liquid, the bacterial composition of the present disclosure can be a nitrifying consortium concentrate that is added to the liquid at the initial rate of 16 liters per 1500 liters of liquid to be treated. In a preferred embodiment, the concentrate of the present disclosure is added to the liquid at the initial rate of 8 liters per 1500 liters of liquid to be treated. In one embodiment, a maintenance dosage of the bacterial consortium of the present disclosure can optionally be added to the liquid at a rate of 2 liters per 1500 liters of liquid to be treated, for example every 2 weeks. In a preferred embodiment, the maintenance dosage of the bacterial consortium of the present disclosure is optionally added to the liquid at a rate of 1 liter per 1500 liters of liquid to be treated, for example every 2 weeks.

Under conditions of aquatic organism rescue, the bacterial composition of the present disclosure can be a nitrifying consortium concentrate that is added to the liquid at the initial rate of 24 liters per 1500 liters of liquid to be treated. In a preferred embodiment, the concentrate of the present disclosure is added to the liquid at the initial rate of 12 liters per 1500 liters of liquid to be treated. In one embodiment, a maintenance dosage of the bacterial consortium of the present disclosure can optionally be added to the liquid at a rate of 12 liters per 1500 liters of liquid to be treated. In a preferred embodiment, the maintenance dosage of the bacterial consortium of the present disclosure is optionally added to the liquid at a rate of 1.5 liters per 1500 liters of liquid to be treated.

In one embodiment, the liquid to which a bacterial composition of the present disclosure is introduced is freshwater. In another embodiment, the liquid is salt water. In an alternative embodiment, the liquid is a combination of freshwater and salt water. Aquatic organisms may be stored in the liquid which is held in a tank or container. Non-limiting examples of suitable tanks or containers are available from Aqualife of Hoersholm, Denmark.

The processes provided herein allow for the treating, rescuing, maintaining, or preserving aquatic organisms in a liquid that is maintained at a temperature of less than or equal to 10° C. In another embodiment, the processes provided herein allow for the treating, rescuing, maintaining, or preserving aquatic organisms in a liquid that is maintained at a temperature of less than or equal to 5° C. In yet another embodiment, the processes provided herein allow for the treating, rescuing, maintaining, or preserving aquatic organisms in a liquid that is maintained at a temperature of less than or equal to 4° C.

In embodiments, the present disclosure relates to a method of treating an aquatic organism in need thereof including contacting a liquid with the aquatic organism therein with an effective amount of bacterial composition, wherein the bacterial composition includes an ammonia oxidizing bacterium and a nitrite oxidizing bacterium, and wherein the temperature of the liquid is less than or equal to 10° C. In embodiments, an effective amount of bacterial composition is an amount sufficient for a beneficial effect. Non-limiting examples of a beneficial effect include improving the quality of the biomass, creating non-toxic conditions, lowered blood pH, increases oxygen conductivity in the blood, improved gill health, and decreased mortality rates for aquatic organisms. The beneficial effect can also be observed by an improved appearance of the biomass or the water it is contained in. In embodiments, the bacterial composition is added to the liquid in an amount capable of removing 0.25-25 mg N—NH₃/L/hr. In embodiments, the bacterial composition is added to the liquid in an amount capable of removing 1-10 mg N—NH₃/L/hr. In embodiments, the amount of ammonia oxidizing bacterium added to the liquid is an amount sufficient to remove 0.25-25 mg N—NH₃/L/hr. In embodiments, the amount of nitrite oxidizing bacterium added to the liquid is an amount sufficient to remove 0.25-25 mg N—NH₃/L/hr. In embodiments, the bacterial composition includes Nitrosomonas eutropha as the ammonia oxidizing bacterium and Nitrobacter winogradskyi as the nitrite oxidizing bacterium. In embodiments, the bacterial composition includes Nitrosomonas eutropha in combination with Nitrobacter winogradskyi. In embodiments, the bacterial composition includes Nitrosococcus as an ammonia oxidizing bacterium in combination with Nitrococcus as a nitrite oxidizing bacterium.

In embodiments, the processes provided herein further allow for the treating, rescuing, maintaining, or preserving aquatic organisms in a liquid by oxidizing ammonium or nitrite present in the liquid for a continuous period of at least 14 days. In a preferred embodiment, the continuous period is at least 28 days. In a particularly preferred embodiment, the continuous period is at least 45 days. In embodiments, the continuous period is 1 day, 2 days, 3 days, 4 days, 5, days, 6 days, 1 week or more, 1 month or more, 2 months or more, 3 months or more.

In one embodiment, at least one buffer compound is added to the liquid to stabilize the pH and alkalinity of the liquid. In preferred embodiment, the at least one buffer compound is NaHCO₃, K₂CO₃, or a combination thereof. The pH of the liquid is maintained in a range of from about 6.8 to about 8.5, with an alkalinity of 20-200 ppm. In a preferred embodiment, the pH of the liquid is maintained in a range of from about 7.2 to about 8.2 with an alkalinity of 50-150 ppm. In a particularly preferred embodiment, the pH of the liquid is be maintained at about 7.8, with an alkalinity of 100 ppm.

In one embodiment, the processes set forth herein may be carried out in tanks or containers. Totes, boxes, tubs or other devices within the tank or container may be used to contain or hold aquatic organisms. The temperature inside the tank or container is, preferably, maintained constant. The tank or container may be provided with various means of maintaining the temperature of the liquid such as, for example, an insulated layer either on the interior or exterior of the tank or container and, optionally, a heat exchanger. The tank or container may include one or more than one drain in the bottom thereof and one or more than one collecting receptacle, preferably, mounted below the container. Any known drain, optionally in combination with a means for collecting/pumping the liquid from the container in the receptacle may be used.

In one embodiment, the tank or container is optionally equipped with at least one biofilter. The biofilter functions to reduce or eliminate water exchanges by converting harmful ammonia to harmless nitrate thereby allowing for a closed loop system. The type of biofilter used may be, for example, an expandable media filter, which comprises a biofilter tank filled with water, plastic biofilter beads and inoculated with a bacterial composition described herein. Any other type of biofilter known to a person skilled in the art may be used.

The tank or container may be aerated by conventional means such as paddle wheels or jet pumps. In one embodiment, the oxygen saturation is maintained at a level from about 40% to about 100%. In a preferred embodiment, the oxygen saturation is maintained at a level from about 70% to about 100%. In a particularly preferred embodiment, the oxygen saturation is maintained at a level of about 100%. In an alternative embodiment, the tank or container may also be unaerated by non-mechanical, natural means. The tank or container in which the aquatic organisms are preserved may also be equipped with a liquid filtration system (e.g., filter tubes) (available from Aqualife of Hoersholm, Denmark).

The tank or container may be also provided with probes/sensors for temperature, humidity, pressure, ammonia, carbon dioxide, pH, or any other parameter deemed necessary for the preservation of aquatic organisms. The tank or container can further include a bio-reservoir tank, one or more protein skimmers, one or more rotating drum filters, any associated plumbing (e.g., valves) for drainage and recycling of liquid, an ultraviolet unit, and an ozone unit for treating toxicity of water returned to the tank, if required for certain applications. Other components, known to a person skilled in the art, may be added to the container. An antibiotic such as cycloheximide may be added to the liquid to inhibit the growth of protists such as amoebas.

The following examples are included for illustrative purposes only and are not intended to limit the scope of the disclosure.

### EXAMPLES

### Demonstrative Example 1

Experiments were conducted to verify the ability of bacteria to control ammonia levels in tanks at 4° C. Marine tank (available from Aqualife of Hoersholm, Denmark) having a capacity of 1.500 liter and a system for refrigeration, aeration, and water circulation were utilized.

Two control group tanks (Group A; Tank 1 and Tank 2) and two experimental group tanks (Group B; Tank 1 and Tank 2) were prepared, the contents of which are summarized in Table 1.

TABLE 1

Biomass - Adult European Eel
(Anguilla Anguilla)

| | Tank 1 (Kg) | Tank 2 (Kg) |
|---|---|---|
| Group A - Control | 300 | 500 |
| Group B - Treatment | 300 | 500 |

Each tank was filled with approximately 1.100 liters of freshwater and the temperature was lowered to 4° C. The pH was maintained at 7.8 with 100% oxygen saturation. Six liters of a bacterial consortium (PTA-6232) including Nitrosomonas eutropha (mean ammonia oxidizing bacterium (AOB) activity of 1500 mg NH₃/L/Hr) and Nitrobacter winogradskyi (nitrite oxidizing bacterium (NOB) activity of 1238 mg NO₂/L/Hr) were prepared and added to each of the tanks in Group B (treatment tanks). The two tanks in Group B (treatment tanks) were treated with 200 grams of NaHCO₃ and 12 grams of K₂CO₃. Next, the biomass (eel) was added to each tank (see Table 1). The levels of ammonium, nitrate, and nitrite were measured at regular intervals. The experimental results for each tank are set forth in Tables 2-5.

TABLE 2
Group A - Control
Tank 1

| | Ammonium | Nitrate | Nitrite | Temp | | Daily |
|---|---|---|---|---|---|---|
| Day | (mg/l) | (mg/L) | (mg/l) | (° C.) | pH | Ammonium |
| 0 | — | 0 | 0 | 4 | 7.8 | 0 |
| 6 | 10.50 | 10.60 | 0.05 | 4 | 7.8 | 1.75 |
| 8 | 14.00 | 11.92 | 0.04 | 4 | 7.8 | 1.75 |
| 13 | 21.00 | 12.72 | 0.07 | 4 | 7.8 | 1.62 |

| | |
|---|---|
| 22 | Test stopped at day 13 - test animals showed signs of distress |

TABLE 3
Group A - Control
Tank 2

| | Ammonium | Nitrate | Nitrite | Temp | | Daily |
|---|---|---|---|---|---|---|
| Day | (mg/l) | (mg/L) | (mg/l) | (° C.) | pH | Ammonium |
| 0 | 0 | 0 | — | 4 | 7.8 | 0 |
| 6 | 14 | 19.6 | 0.11 | 4 | 7.8 | 2.33 |
| 8 | 23 | 23.44 | 0.16 | 4 | 7.8 | 2.88 |
| 13 | 40 | 28.08 | 0.20 | 4 | 7.8 | 3.08 |

| | |
|---|---|
| 22 | Test stopped at day 13 - test animals showed signs of distress |

TABLE 4
Group B - Treatment
Tank 1

| | Ammonium | Nitrate | Nitrite | Temp | | Daily |
|---|---|---|---|---|---|---|
| Day | (mg/l) | (mg/L) | (mg/l) | (° C.) | pH | Ammonium |
| 0 | — | 0 | 0 | 4 | 7.8 | 0 |
| 6 | 1.50 | 51.2 | 0.25 | 4 | 7.8 | 0.25 |
| 8 | 1.94 | 65.2 | 0.28 | 4 | 7.8 | 0.24 |
| 13 | No data available | | | | | |
| 22 | 4.5 | 125.2 | 0.18 | 4 | 7.8 | 0.20 |

TABLE 5
Group B - Treatment
Tank 2

| | Ammonium | Nitrate | Nitrite | Temp | | Daily |
|---|---|---|---|---|---|---|
| Day | (mg/l) | (mg/L) | (mg/l) | (° C.) | pH | Ammonium |
| 0 | — | 0 | — | 4 | 7.8 | 0 |
| 6 | 4.5 | 99.6 | 0.44 | 4 | 7.8 | 0.75 |
| 8 | 7.00 | 128.6 | 0.48 | 4 | 7.8 | 0.88 |
| 13 | 13.00 | 181.2 | 0.71 | 4 | 7.8 | 1.00 |

| | |
|---|---|
| 22 | Test stopped at day 13 - test animals showed |
| | no signs of distress (healthy) |

In Tank 1 of the control group (Group A), the eels demonstrated moderate signs of stress and some mortality had occurred at day 13. The eels exhibited sluggish behavior when stimulated. The water exhibited a greasy feel and appeared cloudy. The experiment was concluded on day 13. In Tank 2 of the control group (Group A), the eels demonstrated clear signs of stress in the form of red gills and sluggish behavior and movement. Some mortality was recorded and the water was reported as having a greasy feel and appeared cloudy. The experiment was concluded on day 13.

In Tank 1 of the experimental group (Group B), the eels showed no sign of stress and no mortality had occurred at day 22. Water was reported as being “crystal clear” and the eels where fully active when stimulated. In Tank 2 of the experimental group (Group B), the eels showed no sign of stress and no mortality had occurred. Water was reported as being “crystal clear” and the eels where fully active when stimulated. The experiment was concluded on day 13. These results demonstrate that the application of nitrifying bacteria at low temperatures can preserve the life of aquatic animals under conditions that otherwise foster lethal or harmful levels of ammonia and nitrite.

### Prophetic Example 1

Various biomass sources held in liquid-containing tanks or containers at low temperatures are treated with the consortium according to the present disclosure. The consortium is added to treat maintain, preserve or rescue aquatic organisms, such as, for example, shellfish, saltwater fish, freshwater fish, crustaceans, molluscs, or reptiles.

### Prophetic Example 2

A consortium of Nitrosococcus as an ammonia oxidizing bacterium and Nitrococcus as a nitrite oxidizing bacterium are used to treat various biomass sources held in liquid-containing tanks or containers at low temperatures according to the procedure set forth in Demonstrative Example 1. The consortium is added to maintain, preserve or rescue aquatic organisms, such as, for example, shellfish, saltwater fish, freshwater fish, crustaceans, molluscs, or reptiles.

### Prophetic Example 3

Various biomass sources held in liquid-containing tanks or containers at low temperatures are treated with the consortium according to the procedure set forth in Demonstrative Example 1. The consortium is added to maintain or preserve aquatic organisms present in the liquid for a time period of at least 30 days. The aquatic organisms include, but are not limited to, shellfish, saltwater fish, freshwater fish, crustaceans, molluscs, or reptiles.

### Prophetic Example 4

Various biomass sources held in liquid-containing tanks or containers may be treated with the consortium according to the present disclosure. The temperature is, however, continuously lowered from an initial temperature of 32° C. to an intermediate temperature of 1° C. over a period of 11 days. Upon reaching an intermediate temperature of 1° C., the temperature is continuously raised back to 32° C. over the remaining 11 days of the test period. The consortium is added to maintain or preserve aquatic organisms throughout the temperature variations. The aquatic organisms include, but are not limited to, shellfish, saltwater fish, freshwater fish, crustaceans, molluscs, or reptiles.

### Demonstrative Example 2

### Cold Temperature Nitrification by Nitrosomonas eutropha and Nitrobacter winogradskyi

A trial setup containing three groups with three replicate test tubes is prepared. Each test tube is prepared with 100 mL of 35 ppt saltwater, pH 8.0 and alkalinity>100 ppm. The dissolved oxygen is kept at >4.0 ppm during the entire experiment by the use of air diffusion. A temperature-controlled water bath is used for temperature control providing an accuracy of +/−0.1 Celsius.

20 ppm of ammonia is added on the initial day of the experiment for all groups. Then, 4000 ppm of a nitrifying consortium including Nitrosomonas eutropha (mean ammonia oxidizing bacterium (AOB) activity of 1500 mg N—NH₃/L/hr) and Nitrobacter winogradskyi (nitrite oxidizing bacterium (NOB) activity of 1238 N—NO₂/L/hr) was added to the treatment tubes at Day 0 of the experiment.

Regular ammonia readings are taken during the experiment (Table 6).

TABLE 6

Ammonia PPM

| Day of | Treatment | Control | Treatment | Control |
|---|---|---|---|---|
| experiment | @ 4 C. | @ 4 C. | @ 23 C. | @23 C. |
| 0 | 20.0 | 20.0 | 20.0 | 19.4 |
| 1 | 19.9 | 20.0 | 10.0 | 16.8 |
| 2 | 18.0 | 19.0 | 0 | 16.4 |
| 3 | 17.6 | 18.1 | 0 | 14.1 |
| 4 | 17.0 | 17.7 | 0 | 13.3 |
| 7 | 15.3 | 17.8 | 0 | 10.5 |
| 8 | 14.5 | 17.8 | 0 | 10.0 |
| 9 | 13.6 | 17.8 | 0 | 9.2 |
| 10 | 12.7 | 17.9 | 0 | 8.9 |
| 11 | 12.4 | 17.9 | 0 | 8.4 |
| 14 | 10.5 | 17.6 | 0 | 8.0 |

The experiment demonstrated that aquatic solutions containing high levels of ammonia can be treated at cold temperatures.

### Demonstrative Example 3

### Cold Nitrification by Nitrosococcus and Nitrococcus

A trial setup containing three groups with three replicate test tubes is prepared, the same as described in Demonstrative Example 2. Now, 4000 ppm of nitrifying consortium including Nitrosococcus and Nitrococcus, with similar ammonia and nitrite oxidation rate levels, were added to the treatment tubes at Day 0 of the experiment.

Regular ammonia readings are taken during the experiment (Table 7).

TABLE 7

Ammonia PPM

| Day of | Treatment | Control | Treatment | Control |
|---|---|---|---|---|
| experiment | @ 4 C. | @ 4 C. | @ 23 C. | @ 23 C. |
| 0 | 20.8 | 21.0 | 20.6 | 21.0 |
| 1 | 20.2 | 21.2 | 17.2 | 19.8 |
| 4 | 19.8 | 20.8 | 12.3 | 17.8 |
| 5 | 19.7 | 19.6 | 9.4 | 17.8 |
| 6 | 19.0 | 19.9 | 7.6 | 15.8 |
| 8 | 14.0 | 19.6 | 3.2 | 15.8 |
| | | | 0 | 15.6 |
| 11 | 13.1 | 18.4 | | |
| 14 | 10.9 | 17.8 | 0 | 15.4 |

The present invention is described by the following numbered paragraphs:
1. A process for nitrifying an aquatic organism-containing liquid comprising
introducing a bacterial composition to the liquid, wherein the bacterial composition includes an ammonia oxidizing bacterium and a nitrite oxidizing bacterium, and wherein the temperature of the liquid is less than or equal to 10° C.
   2. A process for maintaining or reducing nitrite or ammonia levels in a liquid wherein the temperature of the liquid is less than or equal to 10° C. comprising introducing to the liquid a bacterial composition that includes an ammonia oxidizing bacterium and a nitrite oxidizing bacterium.
   3. The process of paragraph 2, wherein the liquid further comprises at least one aquatic organism.
   4. A process for preserving aquatic organisms in an ammonia-containing or nitrite-containing liquid comprising
storing the aquatic organisms in the presence of a bacterial composition that includes an ammonia oxidizing bacterium and a nitrite oxidizing bacterium.
   5. A process for rescuing aquatic organisms in a liquid containing ammonia, nitrite, or a combination thereof comprising:
introducing a bacterial composition to the liquid, wherein the bacterial composition includes an ammonia oxidizing bacterium and a nitrite oxidizing bacterium, and wherein, upon introduction, the bacterial composition begins to oxidize any ammonia or nitrite present in the liquid.
   6. The process of paragraph 5, wherein the temperature of the liquid is less than or equal to 10° C.
   7. A process for transporting live aquatic organisms in a liquid-containing tank comprising
introducing aquatic organisms to the liquid-containing tank; and
introducing a bacterial composition to the liquid, wherein the bacterial composition includes an ammonia oxidizing bacterium and a nitrite oxidizing bacterium, and wherein the temperature of the liquid is at or above the freezing point of the liquid.
   8. The process of paragraph 7, wherein in liquid comprises a component for lowering the standard freezing point of the liquid.
   9. The process of paragraph 7, wherein the tank comprises a means for containing or holding aquatic organisms, a means for maintaining a desired temperature, and a means for aeration.
   10. The process of paragraph 9, wherein the tank further comprises a biofilter.
   11. The process of any of paragraphs 1, 2, or 7, wherein the bacterial composition is introduced to the liquid at a rate of 1-16 liters of bacterial composition per 1500 liters of liquid.
   12. The process of paragraph 1, wherein the bacterial composition has an ammonia oxidation capability of 50-2000 mg N—NH₃/L/Hr.
   13. The process of any of paragraphs 1, 2, 4, 5, or 7, wherein the liquid is salt water, fresh water, or a combination thereof.
   14. The process of any of paragraphs 1, 2, 4, 5, or 7, wherein the temperature of the liquid is less than or equal to 5° C.
   15. The process of any of paragraphs 1, 2, 4, 5, or 7, wherein the temperature of the liquid is equal to or less than 9° C., 8° C., 7° C., 6° C., 5° C., 4° C., 3° C., 2° C., or 1° C.
   16. The process of any of paragraphs 1, 2, 4, 5, or 7, wherein the temperature of the liquid is 1° C.-10° C., 1-5° C. or 1-3° C.
   17. The process of any of paragraphs 1, 2, 4, 5, or 7, wherein the pH of the liquid is between 6.8 and 8.5.
   18. The process of any of paragraphs 1, 2, 4, 5, or 7, wherein liquid exhibits an oxygen saturation of at least 40%.
   19. The process of any of paragraphs 1, 2, 4, 5, or 7, further comprising the step of adding at least one buffer compound to the liquid.
   20. The process of paragraph 19, wherein the at least one buffer compound is NaHCO₃, K₂CO₃, or a combination thereof.
   21. The process of any of paragraphs 1, 2, 4, 5, or 7, wherein the aquatic organism is maintained in the liquid for at least 14 days.
   22. The process of any of paragraphs 1, 2, 4, 5, or 7, wherein the bacterial composition comprises Nitrosomonas eutropha as an ammonia oxidizing bacterium and Nitrobacter winogradskyi as a nitrite oxidizing bacterium.
   23. The process of any of paragraphs 1, 2, 4, 5, or 7, wherein the bacterial composition comprises Nitrosococcus as an ammonia oxidizing bacterium and Nitrococcus as a nitrite oxidizing bacterium.
   24. The liquid according to any one of paragraphs 1, 2, 4, 5, or 7.
   25. A process of aquatic organism resourcing comprising
regulating the level of ammonium and nitrite in an aquatic organism's environment.
   26. The process of paragraph 25, wherein the step of regulating the level of ammonium and nitrite comprises introducing a bacterial composition to the environment, wherein the bacterial composition includes an ammonia oxidizing bacterium and a nitrite oxidizing bacterium.
   27. The process of paragraph 26, wherein the bacterial composition comprises Nitrosomonas eutropha as the ammonia oxidizing bacterium and Nitrobacter winogradskyi as the nitrite oxidizing bacterium.
   28. A method of treating an aquatic organism in need thereof comprising contacting a liquid with the aquatic organism therein with an effective amount of bacterial composition, wherein the bacterial composition includes an ammonia oxidizing bacterium and a nitrite oxidizing bacterium, and wherein the temperature of the liquid is less than or equal to 10° C.
   29. A method in accordance with paragraph 28, wherein the temperature of the liquid is equal to or less than 9° C., 8° C., 7° C., 6° C., 5° C., 4° C., 3° C., 2° C., or 1° C.
   30. A method in accordance with paragraph 28, wherein the temperature of the liquid is 1° C.-10° C., 1-5° C. or 1-3° C.
   31. A method in accordance with paragraph 28, wherein the bacterial composition added to the liquid is capable of removing 0.25-25 mg N—NH₃/L/hr.
   32. A method in accordance with paragraph 28, wherein the amount of ammonia oxidizing bacterium added to the liquid is capable of removing at least 0.25 N—NH₃/L/hr.
   33. A method in accordance with paragraph 28, wherein the amount of nitrite oxidizing bacterium added to the liquid is capable of removing at least 0.25 mg N—NH₃/L/hr.

It will be understood that various modifications may be made to the embodiments disclosed herein. Therefore, the above description should not be construed as limiting, but merely as exemplifications of embodiments. Those skilled in art will envision other modifications within the scope and spirit of the claims appended hereto.

What is claimed is:

1. A process for nitrifying an aquatic organism-containing liquid comprising:
introducing a bacterial composition to the liquid, wherein the bacterial composition includes an ammonia oxidizing bacterium and a nitrite oxidizing bacterium, and wherein the temperature of the liquid is less than or equal to 10° C.

2. A process for rescuing aquatic organisms in a liquid containing ammonia, nitrite, or a combination thereof comprising:
introducing a bacterial composition to the liquid, wherein the bacterial composition includes an ammonia oxidizing bacterium and a nitrite oxidizing bacterium, and wherein, upon introduction, the bacterial composition begins to oxidize any ammonia or nitrite present in the liquid.

3. The process of claim 2, wherein the temperature of the liquid is less than or equal to 10° C.

4. The process of claim 1, wherein the bacterial composition is introduced to the liquid at a rate of 1-16 liters of bacterial composition per 1500 liters of liquid.

5. The process of claim 1, wherein the liquid is salt water, fresh water, or a combination thereof.

6. The process of claim 2, wherein the liquid is salt water, fresh water, or a combination thereof.

7. The process of claim 1, wherein the temperature of the liquid is less than or equal to 5° C.

8. The process of claim 2, wherein the temperature of the liquid is less than or equal to 5° C.

9. The process of claim 1, wherein the pH of the liquid is between 6.8 and 8.5.

10. The process of claim 2, wherein the pH of the liquid is between 6.8 and 8.5.

11. The process of claim 1, wherein liquid exhibits an oxygen saturation of at least 40%.

12. The process of claim 2, wherein liquid exhibits an oxygen saturation of at least 40%.

13. The process of claim 1, further comprising the step of adding at least one buffer compound to the liquid.

14. The process of claim 2, further comprising the step of adding at least one buffer compound to the liquid.

15. The process of claim 1, wherein the bacterial composition comprises Nitrosomonas eutropha as an ammonia oxidizing bacterium and Nitrobacter winogradskyi as a nitrite oxidizing bacterium.

16. The process of claim 2, wherein the bacterial composition comprises Nitrosomonas eutropha as an ammonia oxidizing bacterium and Nitrobacter winogradskyi as a nitrite oxidizing bacterium.

17. The process of claim 1, wherein the bacterial composition comprises Nitrosococcus as an ammonia oxidizing bacterium and Nitrococcus as a nitrite oxidizing bacterium.

18. The process of claim 2, wherein the bacterial composition comprises Nitrosococcus as an ammonia oxidizing bacterium and Nitrococcus as a nitrite oxidizing bacterium.

19. A process of aquatic organism resourcing comprising:
regulating the level of ammonium and nitrite in an aquatic organism's environment.

20. The process of claim 19, wherein the step of regulating the level of ammonium and nitrite comprises introducing a bacterial composition to the environment, wherein the bacterial composition includes an ammonia oxidizing bacterium and a nitrite oxidizing bacterium.
